(19) United States
(12) Patent Application Publication
(10) Pub. No.: US 2010/0228560 A1
(43) Pub. Date: Sep. 9, 2010

(54) PREDICTIVE BUDDY LIST-REORGANIZATION BASED ON CALL HISTORY INFORMATION

(75) Inventors: Mehmet C. Balasaygun, Freehold, NJ (US); Matt Jerome Stevens, Thornton, CO (US); Al Baker, Brick, NJ (US)

Correspondence Address: SHERIDAN ROSS P.C., 1560 BROADWAY, SUITE 1200, DENVER, CO, 80202, US

(73) Assignee: Avaya Inc., Basking Ridge, NJ (US)

(21) Appl. No.: 12/397,452

(22) Filed: Mar. 4, 2009

(51) Int. Cl. G06Q 99/00; G06Q 50/00; G06F 17/30

(52) U.S. Cl. 705/1.1

(57) ABSTRACT

Methods, devices, and systems for organizing contact lists or buddy lists are provided. In one implementation a contact list may be predicatively updated, without user input and not necessarily based upon user provisioned rules, but instead based upon call history information and enterprise information. The predictive organization of the buddy list enables more intelligent communications and may facilitate greater user knowledge of available communication resources.

### FIELD OF THE INVENTION

The invention relates generally to communications and more specifically to maintaining contact lists.

### BACKGROUND

Digital content can be delivered to a large number of devices using many different types of mediums or data formats. With the proliferation of the Internet, the communication modalities supported by a single device has increased significantly. Users can now receive movies, text messages, emails, audio messages, phone calls, music, and other forms of digital content at a single device sometimes with the click of a single button.

With this proliferation of different communication modalities, users have developed a need to organize their communications, contacts, and communication histories. With respect to contact lists, there have been some attempts to organize contact information, but most attempts are somewhat simple and have limited usefulness. As one example, a user's contact list may be organized alphabetically. Efficient use of a contact list organized in a such a way requires the user to know the contact's name and further requires the user to know that they want to contact that particular person before they can find their entry in the contact list. In other words, although alphabetical organization of contact lists provides a logical way of arranging information, it does not necessarily provide for efficient use of information, especially during real-time communications (e.g., phone calls, video calls, etc.) and non-real-time communications (e.g., email, text messaging, chats, etc.).

Other attempts to organize contact information include organizing the contacts based on availability status (i.e., whether the person is AVAILABLE, OFFLINE, ONLINE BUT NOT AVAILABLE, etc.). This is slightly more useful than organizing contact information alphabetically, but still leaves much to be desired. Yet another method of organizing contact information is described in PCT Patent Application No. WO 2007/079,126, the entire contents of which are hereby incorporated by reference. The '126 application describes a method of organizing contact information according to a contact's mood or emotional state. This is somewhat similar to pure state-based organization, but requires the additional step of determining a user's mood. Unfortunately, this particular method is still not particularly useful, especially in most business settings.

### SUMMARY

These and other needs are addressed by embodiments of the present invention. More specifically, the present invention, in one embodiment, provides a predictive mechanism for organizing contact information (e.g., a buddy list or other user information) based on call history information and/or data stored in an enterprise database. This may be particularly useful when setting up a communication device or communication application for a new user. The new user such as a new employee to an enterprise may not be aware of many contacts, especially within that enterprise. Thus, the contact list will likely not be initially useful to the user if it is organized alphabetically. Additionally, the contact list may be re-organized according to call history information (or more generally contact history information) when the user begins initiating a call or when a call is received by the user.

It is one aspect of the present invention to provide for a predictive re-organization of the contact information which allows the user to efficiently utilize the contact information during communications. Predictive re-organization may be based on current contact information as well as historical contact information (e.g., missed calls, outgoing calls, incoming calls, received emails, received messages, the order with which contacts were originated, the number of contacts received in a predetermined amount of time from a particular user, etc.).

In accordance with at least one embodiment of the present invention, a method for organizing contact information is provided that generally comprises:

receiving information about a first user and a second user;

rendering a first user element for displaying at least a portion of the information about the first user in a user contact list;

rendering a second user element for displaying at least a portion of the information about the second user in the user contact list;

retrieving contact history information from a contact log; and

organizing the first and second user elements in the user contact list based on the retrieved contact history information.

There are several ways by which the contact list can be organized based on contact log information. More specifically, information from a missed call log, an incoming call log, an outgoing call log, a message inbox, and/or a deleted message inbox associated with a particular user or collection of users may be considered when organizing the user contact list.

Moreover, different organization algorithms may be employed during the organization step. For instance, the contact list may simply be organized according to the most frequent calls or contactors for the controlling user. Using this algorithm, the number of contacts between (either originated by or directed to a controlling user) a particular user and a controlling user may be counted and used in a weighting algorithm. Users having more contact instances in the contact log with the controlling user may be given a higher ranking that users having less contact instances in the contact log with the controlling user. Thus, the users placed highest on the contact list may be those users who have historically contacted the controlling user more than other users lower on the contact list.

As another example of an organization algorithm that may be used in accordance with at least some embodiments of the present invention, the contact list may be organized when the controlling user either receives or initiates a contact (used herein to include any type of communication between two or more people) with another user. When this triggering event occurs (i.e., either the call receipt or initiation), the controlling user's contact list may be re-organized according to a particular organization algorithm. More specifically, the other user (e.g., the call originating user or the intended recipient) may be identified and that identity may be searched in the controlling user's contact log or the other user's contact log. The organization algorithm may identify each contact instance for that other user and then search for other contacts that are in temporal proximity (e.g., based on time of contact or based on number of entries between contacts) to the identified contact instance. A predetermined range of time or predetermined number of contacts may be searched for other contacts around the identified contact instance. If another user has several contact instances with the controlling user (or the other user) within this predetermined range of time or number of contacts, then that user will be assigned a ranking higher than other users that have a lesser number of contact instances within the same predetermined range of time or number of contacts. Accordingly, the contact list for the controlling user may be re-organized based on the likelihood that he/she might want to contact someone else because he/she historically wanted to contact that someone else either during (e.g., via conference) or just after talking to the current contract originator or intended contact recipient. In other words, the contact habits of the controlling user may be utilized to dynamically re-organize that user's contact list.

It is also one aspect of the present invention to allow a user's contact list to be organized and re-organized based on that user's contact history information as well as the contact history information of other users. Moreover, any type of contact information available within a network may be utilized as an input to the re-organization algorithm. Examples of such information include, but are not limited to, relationships between users in a corporate organization structure, subjects for which the contact is considered a subject matter expert, or any other properties for the contact that are available within the network. These inputs can be used independently or in conjunction with other inputs described herein.

As yet another example of a re-organization algorithm that may be employed in accordance with at least some embodiments of the present invention, a user (caller A) may be on a conference call with two other users (call them users B and C). A re-organization algorithm may be applied whereby user A's call history is reviewed and it is determined that caller A also includes user D and E when he is talking with user B and C simultaneously. In response to this determination, the re-organization algorithm may move users D and E up in importance in user A's contact list, possibly causing them to be placed higher on the contact list than other users. This re-organization may be maintained for the duration of the conference call between users A, B, and C, or could be maintained indefinitely. The length of time for which this re-organization is maintained may depend upon user preferences or other preconfigured rules.

In still another example, a re-organization algorithm may utilize state information for a user's communication device to influence the organization of the contact list. For instance, user A may usually conference with users B, C, and D around 4:00 PM on a daily basis. After one or two instances of such a conference, the re-organization algorithm may recognize the communication pattern/habits of user A by reviewing information stored in user A's call history log, and initiate re-organization of a contact list just before 4:00 PM. Alternatively, when user A begins to dial either user B, C, or D around 4:00 PM (e.g., within a predetermined amount of time, say 15 minutes, before or after 4:00 PM), the re-organization algorithm is smart enough to recognize the pattern of past communications, and promotes the other users not being dialed (e.g., users C and D if user B is being dialed by or is dialing user A). This predictive re-organization of the contact list is facilitated because the re-organization algorithm has determined that user A may want to add them to the call with user B.

It is another aspect of the present invention to utilize the re-organization of the contact list as a triggering event for other actions. For example, the controlling user may be asked whether they want their contact list to be permanently re-organized based on contact history information or whether the controlling user only wants the contact list temporarily re-organized. Other actions that might be triggered by the re-organization of a contact list may include opening communication applications that are different from the one currently being used (i.e., the communication application controlling the contact list) as well as asking the controlling user whether such actions are desired.

As can be appreciated by one skilled in the art, the information displayed or represented in a contact list is different from that being displayed or represented in a contact log. The contact list generally depicts user elements and attributes associated with that user. The contact log generally depicts contact centric information. A contact list is generally not used to depict or render historical contact information such as total contact time, contact origination time, contact ending time, whether the contact was successful (e.g., answered or responded to by the intended recipient of the contact), what users participated in the contact, etc. Rather, the contact list generally depicts information about the user and their general contact information (e.g., work number, mobile number, email address, Instant Messaging (IM) address, Address of Record (AOR), and other parameters associated with that user). Thus, the contact list is different from contact logs in that contact logs comprise some information related to historical contact information whereas the contact list does not comprise historical contact information.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module” or “tool” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of embodiments of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is block diagram depicting a communication system in accordance with at least some embodiments of the present invention;

FIG. 2 is a block diagram depicting a communication device in accordance with at least some embodiments of the present invention;

FIG. 3 is a block diagram depicting data structures in accordance with at least some embodiments of the present invention;

FIG. 4 is a block diagram depicting an exemplary user interface layout in accordance with at least some embodiments of the present invention; and

FIG. 5 is a flow diagram depicting a buddy list re-organization method in accordance with at least some embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any communication application in which it is desirable to maintain an ordered list of contacts.

The exemplary systems and methods of this invention will also be described in relation to analysis software, modules, and associated analysis hardware. However, to avoid unnecessarily obscuring the present invention, the following description omits well-known structures, components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

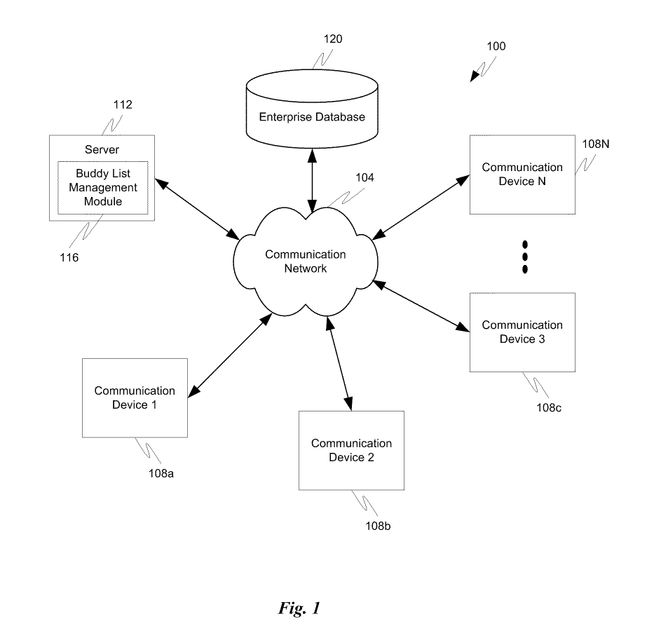

Referring now to FIG. 1, an exemplary communication system 100 will be described in accordance with at least some embodiments of the present invention. The communication system 100 may comprise a communication network 104 that facilitates communications between one or more communication devices 108a-N.

The communication network 104 may be any type of known communication medium or collection of communication mediums and may use any type of protocols to transport messages between endpoints. The communication network 104 may include wired and/or wireless communication technologies. The Internet is an example of the communication network 104 that constitutes and IP network consisting of many computers and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, and any other type of packet-switched or circuit-switched network known in the art. In addition, it can be appreciated that the communication network 104 need not be limited to any one network type, and instead may be comprised of a number of different networks and/or network types.

The communication devices 108a-N may be any type of known communication or processing device such as a personal computer, laptop, Personal Digital Assistant (PDA), cellular phone, smart phone, telephone, contact center resource, or combinations thereof. The communication devices 108a-N may be controlled by or associated with a single user or may be adapted for use by many users (e.g., an enterprise communication device that allows any enterprise user to utilize the communication device upon presentation of a valid user name and password). In general each communication device 108a-N may be adapted to support video, audio, text, and/or data communications with other communication devices 108a-N. The type of medium used by the communication device 108 to communicate with other communication devices may depend upon the communication applications available on the communication device 108.

Additionally, a communication device 108 may subscribe to communication services offered by a communication server 112. As one example, the communication server 112 may correspond to a particular web-based communication application that is partially executed on the server 112 and partially executed by a communication device 108. One example of such a communication application includes an Instant Messaging (IM) application where the server 112 is responsible for sharing certain data about one communication device 108 with another communication device 108 (e.g., presence data related to a presence of a user at a particular communication device 108). The data shared between communication devices 108 via the server 112 may help facilitate more seamless communications between the devices.

In accordance with at least one embodiment of the present invention, the server 112 may be provided with a buddy list management module 116 that is capable of retrieving presence information about the various users (e.g., state, general contact information, user identity, etc.) and their communication devices and share that information with other subscribing users at their communication device 108.

The communication system 100 may also comprise an enterprise database 120 that is used to store various types of enterprise information (e.g., employee information, organizational structure information, enterprise contact information, etc.). In certain instances the server 112 may be adapted to utilize the buddy list management module 116 to access the enterprise database 120 and provide additional enterprise information to various subscribing users. For instance, in addition to providing user identity, general contact information, and state information obtained directly from a communication device, the buddy list management module 116 may also obtain enterprise contact information for the same user as well as information related to that particular user's immediate supervisors and subordinates. This information may be passed along to the user at their communication device 108 to further assist in the organization of contact information at the communication device 108.

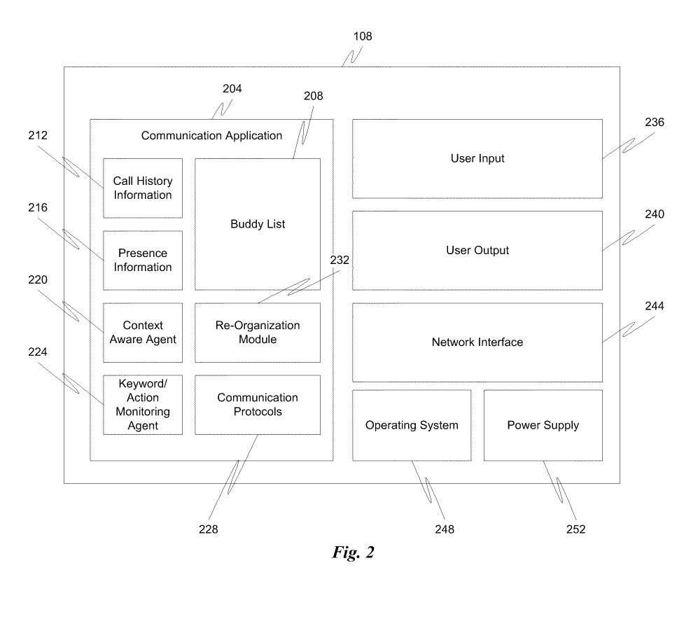

With reference now to FIG. 2, an exemplary communication device 108 will be described in accordance with at least some embodiments of the present invention. The communication device 108 may comprise one or more communication applications 204, at least one of which comprises a buddy list or contact list 208. The buddy list or contact list 208 may be personalized to a controlling user of the communication device 108. More specifically, the buddy list 208 may depict contact information, identification information, and state information (either generally or in relation to use of the particular communication application at another communication device 108) for user's that have been added to the buddy list, usually by election, invitation, or provisioning by the controlling user. Thus, the buddy list 208 may depict information about other users that the controlling user wants to remember and readily access.

The buddy list 208 is a particularly useful tool, especially if it is organized in a meaningful way. Thus, in accordance with at least some embodiments of the present invention, the communication application 204 may further comprise a buddy list re-organization module 232. The re-organization module 232 may be adapted to reference call history information 212 specific to the controlling user as well as call history information related to other users, which may be retrieved from the enterprise database 120. As can be appreciated by one skilled in the art, the call history information 212 may comprise historical contact information related to calls (e.g., total call time, call origination time, call termination time, caller information, callee information, whether other users were conferenced to the call, message information, whether the call was incoming, outgoing, and/or missed, etc.), but may also comprise other contact information (e.g., text message information, email information, etc.) and the nature of such information may depend upon the communication application 204.

In addition to referencing call history information 212, the re-organization module 232 may also be adapted to reference presence information 216, contextual information obtained from a context aware agent 220, and keyword information obtained from a keyword/keyaction monitoring agent 224. This additional information may be utilized to further organize the buddy list 208. The presence information 216 may be obtained from the server 112 or from other presence monitoring service.

The context aware agent 220 may be adapted to monitor communications for their context and the keyword/action monitoring agent 224 may be adapted to monitor communications for certain keywords or combinations of actions to determine if a re-organization of the buddy list 208 is desirable. As one example, the context aware agent 220 may be adapted to learn about a user's (caller or callee) contact preferences based on previous communications, information in the user's call history information 212, etc. to trigger and facilitate buddy list management. Any number of triggers can be used to active the context aware agent 220. Examples of triggers include, but are not limited to, detection of an incoming call from a particular caller, detection of an outgoing call to a particular callee, and so on. Based on information obtained from the context aware agent 220, the re-organization module 232 may be adapted to organize the buddy list 208. Additionally, the re-organization module 232 may add new contacts to the buddy list 208, add contacts from another buddy list, etc. Thus, the re-organization module 232 in connection with the context aware agent 220 may be adapted to organize the buddy list 208 based on user call habits and other actions that are taken by a user during contacts.

The keyword/action monitoring agent 224 may be adapted to monitor communications for keywords and/or monitor user actions for a predetermined series of actions. If a keyword or predetermined number of keywords are detected in a communication or series of communications, then the keyword/action monitoring agent 224 may notify the re-organization module 232 that the buddy list 208 should be re-organized.

In addition to containing a buddy list 208 and various modules for controlling the organization thereof, the communication application 204 also includes communication protocols 228 that are used by the communication application 204 to enable communications across the communication network 104 with other communication devices 108.

The communication device 108 may further include a user input 236, a user output 240, a network interface 244, an operating system 248, and a power supply 252. The operating system 248 is generally a lower-level application that enables navigation and use of the communication application 204 and other applications residing on the communication device 108.

The power supply 252 may correspond to an internal power source such as a battery or the like. Alternatively, or in addition, the power supply 252 may comprise a power converter that is adapted to convert AC power received from a power outlet into DC power that can be used by the communication device 108.

The network interface 244 may include, but is not limited to, a network interface card, a modem, a wired telephony port, a serial or parallel data port, radio frequency broadcast transceiver, a USB port, or other wired or wireless communication network interfaces.

The user input 236 may include, for example, a keyboard, a numeric keypad, and pointing device (e.g., mouse, touch-pad, roller ball, etc.) combined with a screen or other position encoder. Examples of user output devices 216 include an alphanumeric display, a Liquid Crystal Display (LCD), a Light Emitting Diode (LED), a plasma display, a Cathode Ray Tube (CRT) screen, a ringer, and/or indicator lights. In accordance with at least some embodiments of the present invention, a combined user input/output device may be provided, such as a touch-screen device.

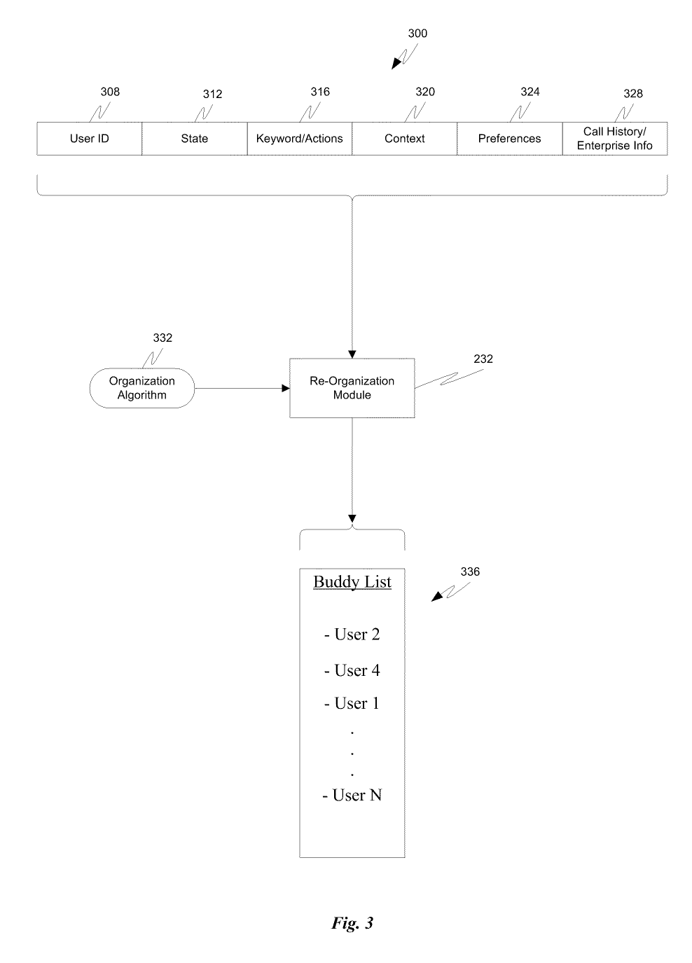

With reference now to FIG. 3, exemplary data structures will be described in accordance with at least some embodiments of the present invention. A first data structure 300 includes a list of contacts 308 and their associated states 312. The first data structure 300 may also include keywords/actions triggers 316, context triggers 320, organization preferences 324, and/or call history/enterprise information 328 for triggering a re-organization of such contacts 308. All of this information is received at the re-organization module 232. Moreover, the re-organization receives an organization algorithm 332 and applies the organization algorithm 332 to the first data structure 300 and outputs an organized buddy list 336. In accordance with at least some embodiments of the present invention, the buddy list 336 is organized based on the call history information retrieved from the local communication device 108, a remote communication device 108, and/or from the enterprise database 120. Thus, a particular user's buddy list 208, 336 may be organized not only based on their call history but also based upon the call history of other users.

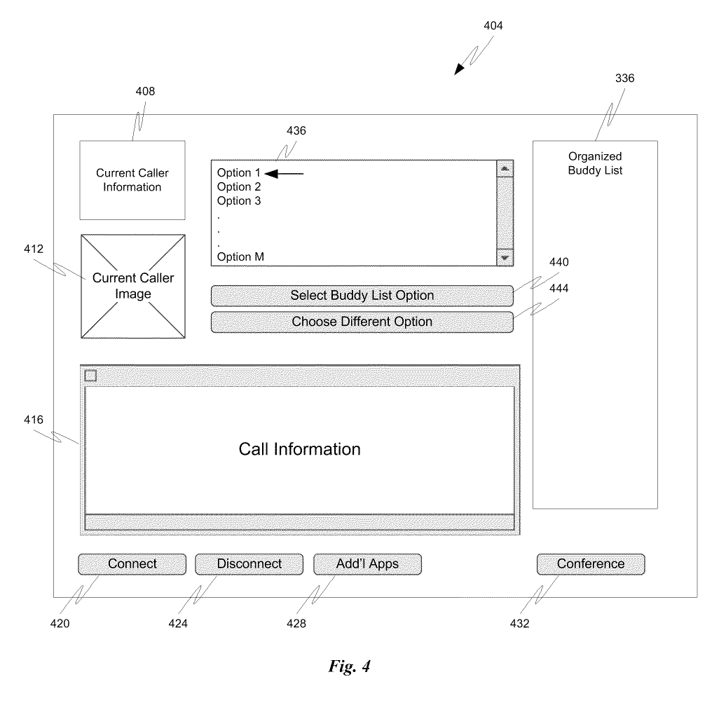

Referring now to FIG. 4, an exemplary graphical user interface 404 is depicted in accordance with at least some embodiments of the present invention. The graphical user interface 404 may be depicted on the communication device 108 via the user output 240 or a combination user input/output. The graphical user interface 404 may depict the organized buddy list 336 as well as other communication information. More specifically, the graphical user interface 404 may depict current caller/contact information 408, an image or icon associated with the current caller 412, more detailed call information 416, a connection input 420, a disconnect input 424, an input for enabling additional communication applications or other applications 428, a conference input 432, a suggested action menu 436, a selection input for the buddy list option 440, and an input for changing the highlighted buddy list option 444.

The selection input for the buddy list option 440 allows a user to select the option highlighted in the suggested action menu 436. The input for changing the highlighted buddy list option 444 allows a user to change the action that is highlighted in the suggested action menu 436. Examples of actions that may be provided on the suggested action menu 436 include various organization algorithms 332 that may be implemented by the re-organization module 232 and/or various parameters that can be used as inputs for organizing the buddy list.

Based on user inputs received at these graphical user interface elements, the re-organization module 232 implements the appropriate re-organization algorithm. A user is also enabled to control the various other features of the communication algorithm 204 and the communication device 108 in general via the graphical user interface 404.

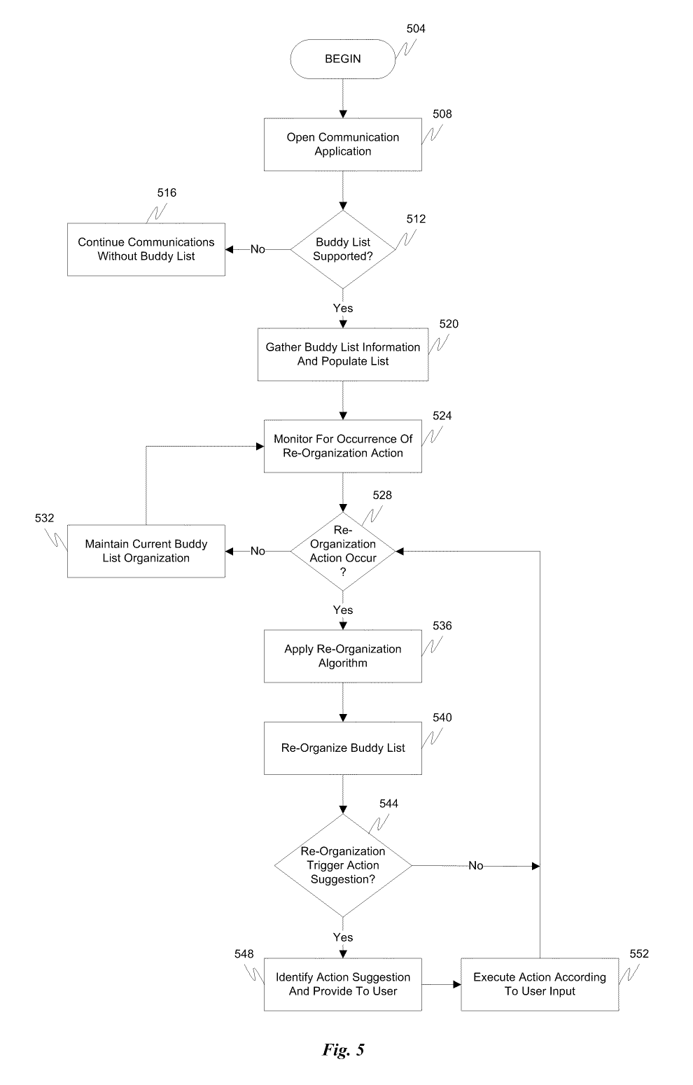

With reference now to FIG. 5, an exemplary buddy list re-organization method will be described in accordance with at least some embodiments of the present invention. The method begins at step 504 and continues when a communication application 204 is opened by a user (usually via the operating system 248 (step 508). Thereafter, the determination is made as to whether or not the communication application 204 includes or supports a buddy list (step 512). If the communication application 204 does not include or support a buddy list, then the method continues with normal communications without a buddy list (step 516).

If, however, a buddy list is supported by the communication application 204, then the method continues with the communication application 204 gathering the necessary information to populate the buddy list (step 520). This information may be obtained from local memory and/or from the enterprise database 120. The information used to populate the buddy list may include user identification information, general user contact information (e.g., phone number, email address, IM address, IP address, Address of Record (AOR), etc.), user status information (e.g., ONLINE, OFFLINE, BUSY, AVAILABLE, etc.), and so on. The information is used to populate the buddy list according to a first organization scheme. For example, the contacts of a particular user may be organized alphabetically or based on status information initially.

Thereafter, the method continues by waiting for the occurrence of a re-organization action (steps 524 and 528). Examples of re-organization actions include, but are not limited to, receiving a user input indicating a desire to re-organize the buddy list, receiving an incoming contact (e.g., call, email, text message, video call, etc.), determining that an outgoing contact is being initiated or has been initiated by the controlling user, determining that the communication device 108 is undergoing initial setup, and the like.

If no re-organization action is detected in step 528, the method proceeds by maintaining the current buddy list organization (step 532). If a re-organization action does occur, then the method proceeds by applying a selected re-organization algorithm (step 536). A re-organization algorithm may correspond to a single re-organization algorithm or combinations of re-organization algorithms. Some examples of re-organization algorithms include ranking contacts in the buddy list based on the number of entries a particular user has in the call history information, raking contacts based on their temporal proximity in the call history to the most recent or current contact, ranking contacts based on the types of communication applications historically used by that user, ranking contacts based on their relationship (enterprise or familial) with the user, and so on.

Application of one or more of these re-organization algorithms by the re-organization module 232 results in a re-organization of the buddy list (step 540). Thereafter, the re-organization module may be further adapted to determine whether the re-organization of the buddy list triggers another action or an action suggestion (step 544). If the re-organization of the buddy list was not a trigger for any further actions, then the method returns to step 528.

If, on the other hand, the re-organization of the buddy list does trigger another action or action suggestion, then the method proceeds with the re-organization module identifying an action suggestion for the user and providing that suggestion to the user, typically via the graphical user interface 404 (step 548). In accordance with at least one embodiment of the present invention, the suggested action may be displayed and possibly highlighted in the suggested action menu 436.

The re-organization module 232 then awaits a user input before executing any further actions (step 552). Of course, the user may elect one or several action options to be executed. Examples of actions that may be triggered and suggested to the user by the re-organization module 232 include, without limitation, opening a communication application other than the one currently being employed, initiating a new contact with another user, conference another user into the current contact, enabling a new feature of the communication application currently being employed, and combinations thereof. Alternatively, if the user has preconfigured the re-organization module 232 to automatically execute certain actions if certain criteria are met, then the identified action may be automatically executed without any additional user input. The re-organization module 232 may, however, notify the user that the additional actions have been executed. Thereafter, the method returns to step 528.

While embodiments of the present invention have been described in connection with re-organizing a contact list, one skilled in the art will appreciate that a literal re-ordering within the user interface is not necessarily required by the present invention. While re-organization may take the form of a literal re-ordering of the contact list, re-organization may also take the form of highlighting or otherwise prioritizing contacts within an existing sort order, or through additional user interface elements that duplicate prioritized contacts at the top of the list or in some other visible way. Such an approach would provide the user with both the benefits of prioritization as well as allows the user to manually browse or search their contacts in a familiar order.

While the above-described flowchart has been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the communication and computer arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script (although the invention is not limited to these technologies), as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for organizing contact lists and providing communications suggestions based thereon. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method of organizing information about two or more users, comprising:
receiving information about a first user and a second user;
rendering a first user element for displaying at least a portion of the information about the first user in a user contact list;
rendering a second user element for displaying at least a portion of the information about the second user in the user contact list;
retrieving contact history information from a contact log; and
organizing the first and second user elements in the user contact list based on the retrieved contact history information.

2. The method of claim 1, wherein the contact log comprises at least one of a missed contact log, an incoming contact log, an outgoing contact log, a message inbox, and a deleted message inbox.

3. The method of claim 2, wherein the user contact list comprises a buddy list, wherein the information displayed about the first user and second user comprise user identity and user contact information.

4. The method of claim 3, wherein the information displayed about the first user and second user further comprise a communication application used to contact the first user and second user.

5. The method of claim 3, wherein the information displayed about the first user and second user further comprise status information.

6. The method of claim 1, further comprising:
receiving a contact from a contact originating user;
searching the contact log for contact instances associated with the contact originating user;
ranking users based on a number of contacts initiated by users or directed toward users within a predetermined number of contacts before or after the contact instances associated with the contact originating user; and
utilizing the ranking to organize the user contact list.

7. The method of claim 1, further comprising:
determining that the organization of the user contact list triggers an action suggestion;
identifying an action suggestion based on the trigger;
providing the identified action suggestion to a user; and
executing the action according to input received from the user.

8. The method of claim 1, further comprising:
accessing enterprise information from an enterprise database; and
utilizing the enterprise information to organize the user contact list.

9. The method of claim 1, wherein the first user and second user are users which have been selectively added to the user contact list by a third user that controls the user contact list.

10. The method of claim 1, further comprising:
determining user contact habits from the contact log; and
utilizing information about the user contact habits to organize the user contact list.

11. A computer readable medium encoded with processor executable instructions operable to perform the method of claim 1.

12. A graphical user interface for displaying information about more than one user to an operating user, the graphical user interface comprising:
a first user element depicting information about a first user; and
a second user element depicting information about a second user;
wherein the first and second user elements are organized according to rankings determined for the first and second users and the relative value of each ranking, wherein the ranking for each user is determined based on contact history with the respective user and the operating user.

13. The graphical user interface of claim 12, wherein the first and second user elements further depict status information related to the first and second user, respectively.

14. The graphical user interface of claim 13, wherein the first and second user elements comprise user identity and user contact information and wherein contact history comprises information retrieved from at least one of a missed contact log, an incoming contact log, an outgoing contact log, a message inbox, and a deleted message inbox associated with the operating user.

15. A communication device comprising the graphical user interface of claim 12.

16. A communication device, comprising:
a communication application that includes a contact list for displaying user elements associated with users other than a user that is operating the communication device, the communication application further comprising a re-organization module; and
a user output operable to display the contact list, wherein the re-organization module is operable to reference contact history information, rank users associated with user elements in the contact list based on a number of contacts associated with such users in the contact history information, and organize the user elements in the contact list based on the ranking of users.

17. The communication device of claim 16, further comprising a network interface operable to receive a contact from a contact originating user, wherein the re-organization module is further operable to determine that the contact has been received from the contact originating user and in response to search the contact history information for contact instances associated with the contact originating user and the operating user, rank users based on a number of contacts initiated by users or directed toward users within a predetermined number of contacts before or after the contact instances associated with the contact originating user and operating user, and utilize the ranking to organize the user contact list.

18. The communication device of claim 16, wherein the re-organization module is further operable, for each user associated with a user element in the contact list, to determine a number of contact instances in the contact log associated with each user, determine a total number of contact instances in the contact log for each user, rank the users based the total number of contact instances in the contact log from each user, wherein a user having a greater total number of contact instances is assigned a higher ranking than a user having a lesser total number of contact instances, and utilize the ranking to organize the user contact list.

19. The communication device of claim 16, wherein the information displayed by the user elements about its associated user includes user identity, user contact information, user status information, and information related to a communication application used by the controlling user to contact the other users.

20. The communication device of claim 16, wherein the re-organization module is further operable to determine that the organization of the user contact list triggers an action suggestion, identify an action suggestion based on the trigger, and provide the identified action suggestion to the controlling user.
